(19) United States
(12) Patent Application Publication
(10) Pub. No.: US 2012/0254608 A1
(43) Pub. Date: Oct. 4, 2012

(54) SSL VPN GATEWAY AND SSL VPN TUNNEL ESTABLISHING METHOD

(75) Inventor: MING-CHIN HO, Tu-Cheng (TW)

(73) Assignee: HON HAI PRECISION INDUSTRY CO., LTD., Tu-Cheng (TW)

(21) Appl. No.: 13/211,240

(22) Filed: Aug. 16, 2011

(30) Foreign Application Priority Data
Mar. 31, 2011 (CN) 201110080463.X

(51) Int. Cl. H04L 9/00

(52) U.S. Cl. 713/153

(57) ABSTRACT

A Secure Socket Layer Virtual Private Network (SSL VPN) gateway for establishing a SSL VPN tunnel with another SSL VPN gateway includes a storage unit, a processor and a tunnel establishing unit. The storage unit stores a plurality of packet criterions and a plurality group of parameter set values. The tunnel establishing unit includes a tag generator, an initiator, and a negotiator. The tag generator generates a plurality of tags corresponding to the packet criterion and attaches the tags to packets which meet the corresponding packet criterions. When the initiator receives the tagged packets, the initiator initiates the negotiating to negotiate with another gateway for establishing a SSL VPN tunnel according to the group of parameter set values corresponding to the tagged packets.

### BACKGROUND

1. Technical Field

The disclosure generally relates to Secure Socket Layer Virtual Private Network (SSL VPN) technologies, and particularly to a SSL VPN gateway and a SSL VPN tunnel establishing method.

2. Description of Related Art

SSL VPN is a Virtual Private Network (VPN) technology that implements remote access by using a Secure Socket Layer (SSL) encryption connection. In a network structure of the SSL VPN, an SSL VPN tunnel is established between an SSL VPN gateway and a remote host or another SSL VPN gateway, and packets are transmitted on the internet in an encryption mode through the SSL VPN tunnel. Nowadays, most SSL VPN is used in a remote access mode or in a site to site mode. However, in above modes, the SSL VPN gateway establishes the SSL VPN tunnel by setting the SSL VPN tunnel values manually, which is inconvenient.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure

FIG. 1 is a block diagram of a SSL VPN gateway, according to an exemplary embodiment.

FIG. 2 is a flowchart of an exemplary method of using the SSL VPN gateway shown in FIG. 1 to establishing a SSL VPN tunnel with another SSL VPN gateway.

### DETAILED DESCRIPTION

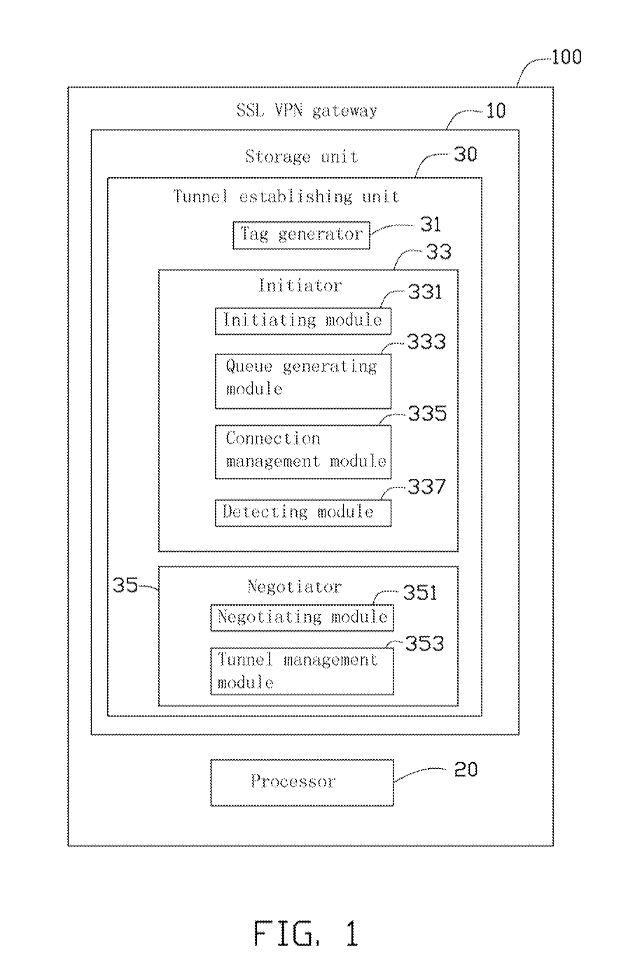

FIG. 1 shows a block diagram of a SSL VPN gateway 100, according to an exemplary embodiment. The SSL VPN gateway 100 includes a storage unit 10, a processor 20, and a tunnel establishing unit 30. The tunnel establishing unit 30 comprises one or more software programs stored in the storage unit 10 and can be executed by the processor 20 to establish a SSL VPN tunnel with another SSL VPN gateway for transmitting packets.

The storage unit 10 also stores a plurality of packet criterions and a plurality of groups of SSL VPN parameter set values. In this exemplary embodiment, the packet criterion is defined to be information such as source IP address, destination IP address, protocol, source IP port, destination IP port of the packet received from the another SSL VPN gateway that can be used to classify the received packets. For example, one of the packet criterions can be that the source IP address is 1.1.1.1, and the destination IP address is 2.2.2.2. In one example, if one or more packets include the above information, the packet meets the packet criterion. The SSL VPN parameter set values are used to establish the SSL VPN tunnel.

The tunnel establishing unit 30 includes a tag generator 31, an initiator 33, and a negotiator 35. The tag generator 31, the initiator 33, and the negotiator 35 comprise one or more computerized code stored in the storage unit 10 and can be executed by the processor 20 to perform corresponding operations of the SSL VPN gateway 100.

The tag generator 31 generates a plurality of tags corresponding to the packet criterions stored in the stored unit 10 and attaches the tag to the packet which meets the corresponding packet criterion. Each tag is defined to be markers inserted or embedded into data of the packets that can be used to identify and distinguish the packets which meets the corresponding packet criterions. In addition, each tag corresponds to one group of SSL VPN parameter set values. That is, each packet criterion corresponds to one group of SSL VPN parameter set values. In addition, the tunnel establishing unit 30 also establishes a connection between the SSL VPN gateway 100 and the another SSL VPN gateway when the packet is received from the another SSL VPN gateway. The tag generator 31 also attaches the tag that corresponds to the packet to the connection.

The initiator 33 includes an initiating module 331 and a queue generating module 333. The initiating module 331 receives the packet attached with the tag and initiates the negotiator 35 to negotiate with the another SSL VPN gateway to establish the SSL VPN tunnel.

The queue generating module 333 generates a queue according to the connection of the tagged packet, and temporarily stores the packets which are received during a time period of when the negotiator 35 negotiates with the another SSL VPN gateway in the queue.

The negotiator 35 includes a negotiating module 351. The negotiating module 351 negotiates with the another gateway for establishing the SSL VPN tunnel If negotiating module 351 succeeds in negotiating with the another SSL VPN gateway, the SSL VPN tunnel can be established, and the packets stored in the queue are transmitted in the SSL VPN tunnel via the connection. Otherwise, if the negotiating module 351 fails to negotiate with the another SSL VPN gateway, the SSL VPN tunnel cannot be established, the initiating module 331 informs a client of the another SSL VPN gateway to reestablish a SSL VPN tunnel or transmit the packets by normal internet network.

In other embodiments, the initiator 33 further includes a connection management module 335 and a detecting module 337.

The connection management module 335 manages the connection of the tagged packet in the SSL VPN tunnel. When the connection management module 135 detects the connection of the tagged packet is disconnected, the connection management module 135 informs the negotiating module 351 to terminate the SSL VPN tunnel.

The detecting module 337 detects states of the SSL VPN tunnel, and informs the negotiator 35 to terminate the SSL VPN tunnel when the SSL VPN tunnel is idle. An idle status can be determined according to whether a certain type packet has been transmitted through the SSL VPN tunnel during a certain period. For example, the SSL VPN tunnel is idle when the detecting module 337 detects that no TCP/IP packet has been transmitted through the SSL VPN tunnel within five minutes.

In addition, the negotiator 35 further includes a tunnel management module 353. The tunnel management module 353 manages the SSL VPN tunnels. When the SSL VPN tunnel is abnormal or terminated, the tunnel management module 353 informs the client terminal by the initiating module 331.

In general, the word “module”, as used herein, refers to logic embodied in hardware or firmware, or to a collection of software instructions, written in a programming language, such as, Java, C, or Assembly. One or more software instructions in the modules may be embedded in firmware, such as in an EPROM. The modules described herein may be implemented as either software and/or hardware modules and may be stored in any type of computer-readable medium or other storage device.

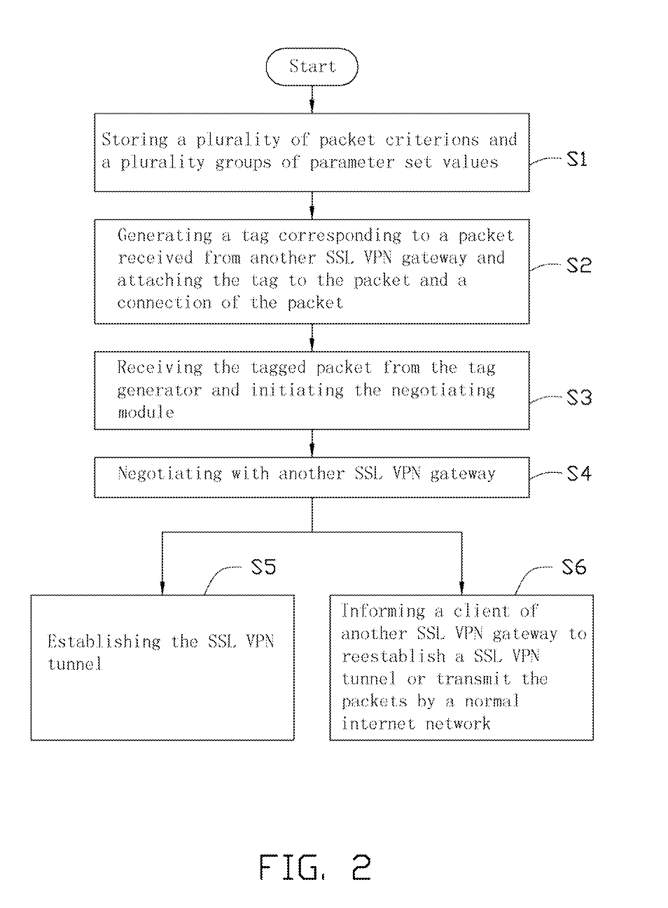

Referring to FIG. 2, a process of using the SSL VPN gateway 100 to establish a SSL VPN tunnel with another SSL VPN gateway may include following steps. It should be known that depending on the embodiment, additional or less steps may be added or the ordering of the steps may be changed.

In step S1, the storage unit 10 stores a plurality of packet criterions used to classify the received packets and a plurality of groups of SSL VPN parameter set values used to establish SSL VPN tunnels.

In step S2, the tunnel establishing unit 30 receives a packet from the other SSL VPN gateway and establishes a connection of the packet between the SSL VPN gateway 100 and the another SSL VPN gateway. When the packet meets the packet criterion stored in the storage unit 10, the tag generator 31 generates a tag corresponding to the packet, and attaches the tag to the packet and the connection of the packet.

In step S3, the initiating module 331 receives the tagged packet from the tag generator 31, and initiates the negotiating module 351. The queue generating module 333 generates a queue according to the tagged connection, and stores the packets in the queue when the negotiating module 351 negotiates with the another SSL VPN gateway.

In step S4, the negotiating module 351 negotiates with the another SSL VPN gateway. If the negotiating module 351 succeeds in negotiating with the other SSL VPN gateway, the processes go to step S5. If the negotiating module 351 fails to negotiate with the another SSL VPN gateway, the process goes to step S6.

In step S5, the SSL VPN tunnel can be established according to a group of SSL VPN parameter set values which are stored in the storage unit 10 and corresponding to the packet, and the packets stored in the queue are transmitted in the SSL VPN tunnel via the connections.

In step S6, if the negotiating module 351 fails in negotiating with the another SSL VPN gateway, the SSL VPN tunnel cannot be established, the initiating module informs the client of the another SSL VPN gateway to reestablish a SSL VPN tunnel or transmit the packets by normal internet network.

The SSL VPN gateway 100 generates the corresponding tag for the packet, and automatically establishes the SSL VPN tunnel when the initiating module 331 receives the tagged packet, which is convenient. In addition, the SSL VPN tunnel can be terminated when the SSL VPN tunnel is idle or the connection of the packet is disconnected, thus, the network source can be saved.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A Secure Socket Layer Virtual Private Network (SSL VPN) gateway, comprising:
a storage unit that stores a plurality of packet criterions used to classify packets received from another gateway and a plurality group of parameter set values used to establish SSL VPN tunnels; a processor; and
at least one modules stored in the storage unit and executed by the at least one processor, the at least one modules comprising:
a tag generator generating a plurality of tags corresponding to the packet criterion and the group of parameter set values, and attaching the tags to packets of the received packets which meet the corresponding packet criterions;
an initiator, comprising:
an initiating module receiving the tagged packet; and
a negotiator, comprising:
a negotiating module initiated by the initiating module when the initiating module receives the tagged packet to negotiate with another gateway for establishing a SSL VPN tunnel according to the group of parameter set values corresponding to the tagged packet.

2. The SSL VPN gateway of claim 1, wherein the initiator further comprises a queue generating module generating a queue according to a connection of the tagged packet, and temporarily storing the packets which are received during a period when the negotiating module negotiates with the another gateway in the queue.

3. The SSL VPN gateway of claim 1, wherein the initiator further comprises a connection management module managing a connection of the tagged packet in the SSL VPN tunnel, when the connection management module detects the connection of the tagged packet is disconnected, the connection management module informs the negotiating module to terminate the SSL VPN tunnel.

4. The SSL VPN gateway of claim 1, wherein the initiator further comprises a detecting module, the detecting module detects states of the SSL VPN tunnel, and informs the negotiating module to terminate the SSL VPN tunnel when the SSL VPN tunnel is idle.

5. The SSL VPN gateway of claim 4, wherein an idle status is determined according to whether a certain type packet has been transmitted through the SSL VPN tunnel during a certain period.

6. The SSL VPN gateway of claim 1, wherein the negotiator further includes a tunnel management module, the tunnel management module manages the SSL VPN tunnels, when the SSL VPN tunnel is abnormal or terminated, the tunnel management module informs a client of the another SSL VPN gateway to reestablish a SSL VPN tunnel or transmit the packets by normal internet network.

7. The SSL VPN gateway of claim 1, wherein the packet criterion is set according to information of the packets.

8. A computer-implemented method for establishing a Secure Socket Layer Virtual Private Network (SSL VPN) tunnel, comprising:
storing a plurality of packet criterions used to classify packets received from another gateway and a plurality groups of parameter set values used to establish SSL VPN tunnels;
generating a tag corresponding to the packet criterions;
attaching the tag to packets of the received packets which meets the corresponding packet criterion;
negotiating with another gateway when the tagged packet is received; and
establishing a SSL VPN tunnel according to the group of parameter set values corresponding to the tagged packet when successfully negotiating with the another gateway.

9. The method of claim 8, further comprising managing connections of the tagged packet in the SSL VPN tunnel, and terminating the SSL VPN tunnel when some connection of the tagged packet is disconnected.

10. The method of claim 8, further comprising detecting states of the SSL VPN tunnel, and terminating the SSL VPN tunnel when the SSL VPN tunnel is idle.

11. The method of claim 10, wherein an idle status is determined according to whether a certain type packet has been transmitted through the SSL VPN tunnel during a certain period.

12. The method of claim 8, wherein managing the SSL VPN tunnels, when some SSL VPN tunnel is abnormal or terminated, informing a client of the another SSL VPN gateway to reestablish a SSL VPN tunnel or transmit the packets by normal internet network.

13. The method of claim 8, wherein the packet criterion is set according to information of the packets.
